(19) United States
(12) Patent Application Publication
(10) Pub. No.: US 2018/0063311 A1
(43) Pub. Date: Mar. 1, 2018

(54) INTERACTIVE REMOTELY CONTROLLABLE PORTABLE WIRELESS SPEAKER SYSTEM

(71) Applicant: Braven LC, Orem, UT (US)

(72) Inventors: Andy Fathollahi, Corona Del Mar, CA (US); Scott Lee Emery, Lehi, UT (US); Kevin David Yuichi Suda, Irvine, CA (US); Marko Medic, Amberg (DE)

(21) Appl. No.: 15/399,730

(22) Filed: Jan. 5, 2017

Related U.S. Application Data
(60) Provisional application No. 62/275,227, filed on Jan. 5, 2016.
(60) Provisional application No. 62/275,724, filed on Jan. 6, 2016.

(51) Int. Cl. H04M 1/725; H04W 4/00; H04W 76/02

(52) U.S. Cl. CPC H04M 1/7253; H04W 76/023; H04W 4/008

(57) ABSTRACT

An interactive remotely controllable portable wireless speaker system is disclosed. The speaker systems includes a Bluetooth enabled speaker and an application configured to communicate and control the functionality of the speaker remotely via a Bluetooth connection. The application is configured to allow the speaker to, among other things, be powered on and off automatically, switch from one audio source to another, control the auxiliary port on the speaker, initiate an alarm when connectivity falls below a pre-defined level, map the location where the speaker connectivity drops below a pre-defined level to allow for the user to locate a lost or misplaced speaker, disable the physical buttons on the speaker such as volume and power to mitigate against unwanted tampering of the speaker; and control the audio equalizer settings either via custom settings or pre-determined equalizer genre settings. The software application can also initiate pairing of the speaker with audio sources and control the volume of the speaker and facilitate the use of multiple speakers on separate left and right channels.

### INCORPORATION BY REFERENCE TO RELATED APPLICATIONS

This application claims the benefit of priority under 35 U.S.C. §119(e) to U.S. Provisional Application No. 62/275,227, filed Jan. 5, 2016 and titled “INTERACTIVE REMOTELY CONTROLLABLE PORTABLE WIRELESS SPEAKER SYSTEM” and U.S. Provisional Application No. 62/275,724, filed Jan. 6, 2016 and titled “INTERACTIVE REMOTELY CONTROLLABLE PORTABLE WIRELESS SPEAKER SYSTEM”. The above applications are hereby incorporated herein by reference in their entirety and are to be considered as parts of this specification.

### BACKGROUND OF THE INVENTION

### Field of the Invention

This patent document relates to interactive remotely controllable portable speaker systems.

### Description of the Related Art

Portable Bluetooth wireless speaker systems receive audio from a user's smartphone, tablet computer, MP3 players, or other Bluetooth enabled electronic device and playback's amplified audio on speakers built to the speaker system. Their portable size and their self-contained power supplied by rechargeable batteries contained within the speaker housing allow the user to enjoy enhanced sound anywhere, even when conventional power sources are absent and make such speakers travel friendly. Such speakers, however, have limited remote interactive user controls, require manual manipulation for operation, even after being paired to the audio source device, and are often misplaced or lost. Such issues undermine the user experience of conventional Bluetooth speakers.

Accordingly, the inventors here have recognized these shortcomings and have found that such speaker systems may be improved upon as described herein.

### SUMMARY OF THE INVENTION

Various aspects of the disclosed system are disclosed herein, including in the drawings. Such aspects may be combined to form claims for a device, apparatus, system, method of manufacture, and/or use without limitation.

### BRIEF DESCRIPTION OF THE DRAWINGS

Features, aspects and advantages are described below with reference to the drawings, which are intended to illustrate but not to limit the invention. In the drawings, like reference characters denote corresponding features consistently throughout similar embodiments.

FIG. 1 is a view of an illustrative example of an interactive remotely controllable portable wireless speaker system and a mobile device executing a software application for interactively remotely controlling the portable wireless speaker system in accordance with the present teachings.

FIG. 2 shows an exemplary screenshot from a mobile device executing the software application of FIG. 1 displaying a list of available BLE speakers.

FIG. 3 shows an exemplary screenshot from a mobile device executing the software application of FIG. 1 displaying a detailed view of Speaker Controls.

FIG. 4 shows an exemplary screenshot from a mobile device executing the software application of FIG. 1 displaying an interactive settings menu for selecting speaker-settings.

FIG. 5 shows an exemplary screenshot from a mobile device executing the software application of FIG. 1 displaying an interactive menu for selecting audio source.

FIG. 6 shows an exemplary screenshot from a mobile device executing the software application of FIG. 1 displaying an interactive menu for selecting equalizer pre-sets.

FIG. 7 shows an exemplary screenshot from a mobile device executing the software application of FIG. 1 displaying the speaker settings interactive menu.

Each drawing is generally to scale and hence relative dimensions of the various layers can be determined from the drawings. Common or corresponding elements in each drawing are referred to using the same reference numerals.

### DETAILED DESCRIPTION OF THE PREFERRED EMBODIMENT

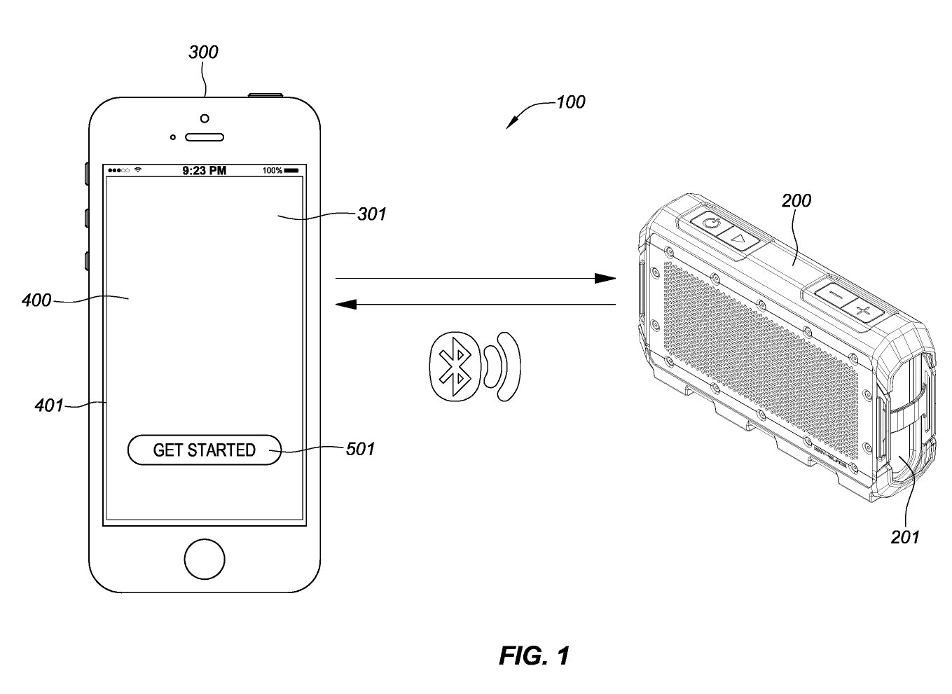

As described herein and illustrated in the drawings, disclosed herein are various aspects of an interactive remotely controllable portable wireless speaker system 100 that as illustrated in FIG. 1 includes a Bluetooth Smart Technology (Bluetooth Low Energy or BLE) enabled wireless speaker 200 and an interactive audio application 400 that can be downloaded and stored in non-transient memory on the user's BLE enabled audio source device 300, which may include an interactive touch screen display 301. BLE is a wireless personal area network technology designed and marketed by the Bluetooth Special Interest Group, the specifications of which can be found at https://www.bluetooth.com/specifications/adopted-specifications. The BLE speaker 200 may also include an auxiliary port 201 that is configured to be connected via a cable to an external supplemental audio source that when connected can play audio through the speaker 200.

The audio application 400 may, for example, be operable on mobile operating systems including, iOS, Android, Windows, Blackberry and others that natively support BLE so as to be capable of communicating with the BLE speaker 200. FIG. 1, and the other drawings herein, illustrates the application 400 on an iPhone 6 smart phone that operates on Apple iOS. The audio application 400 utilizes BLE to send commands and receive communications from the BLE enabled speaker 200. The commands vary from turning “on” and “off” the speaker power to managing Bluetooth audio sources, like an iPhone 6 smartphone, that is capable of communicating with BLE speaker devices.

Such BLE speaker devices, may be BLE enabled using various BLE chip platforms. For example, the CSR8675™ chip (now produced by Qualcomm Inc.), which provides a consumer audio platform for wired and wireless applications that integrates an ultra-low-power DSP and application processor with embedded flash memory, a high-performance stereo codec, a power management subsystem, LED and LCD drivers and capacitive touch sensor inputs has been found suitable for this application. The following table provides an overview of the CSR8675™ chip:

I. System Features
Bluetooth ® 4.1 support
16 Mb eflash and up to 64 Mb external serial flash
Increased DSP performance up to 120 MHz
RF Perf: Tx: +10 dBm, Rx −90 dBm (DQPSK)
6 x Capacitive touch sensors inputs
2 x additional GPIOs
II. Audio
Integrated high performance stereo DAC & ADCs
Up to six digital microphone inputs
Support for ANC feed-forward architecture
24 bit digital audio support
2 x I2S Interfaces
SPDIF bit clock to determine sample rates
III. Power Management
2 x highly efficient SMPS with smaller external
components
USB 3.3 V regulator
Integrated linear regulators
IV. Battery Charger
Li-ion battery charger with for support up to 200 mA
charge currents and option for higher charge
currents using BJT
V. Package Options
BGA & WLCSP (Pin compatible with CSR8670)

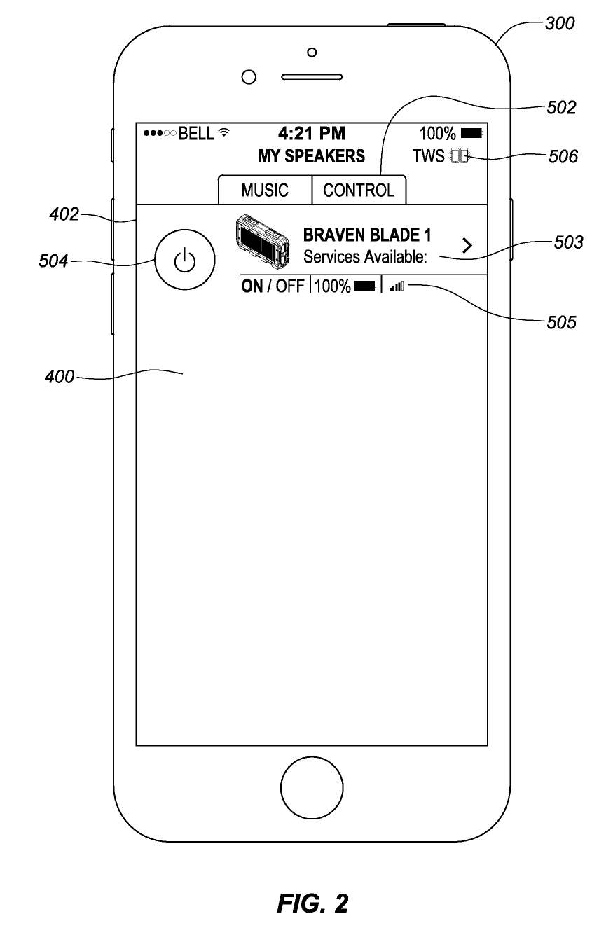

Once the audio application 400 is launched various interactive screens with various user interface touchscreen buttons are generated by the application and presented to the user on the touchscreen of the audio source 300. The various screens and buttons and their respective information and functions are described in detail below. Initially, after launch of the application 400, a start screen 401 (illustrated in FIG. 1) is generated by the application 400 on the touchscreen of the audio source 300 that prompts the user to “get started”. Once the user selects the “get started” button 501, the user is presented with a screen 402 (illustrated in FIG. 2) that includes a “Control Tab” 502, which provides a list of available BLE speakers 503 that can be controlled by the application 400. The available speakers 403 listed include speakers that have been previously paired with the audio source device 300.

To the left of each listed speaker a Power Button symbol 504 is generated by the application 400 and presented to the user. The Power Button symbol 504, acts as both a display for the power state of a listed connected speaker 200 (e.g., when the button is blue indicates the speaker power is on and when the button is black indicates the speaker power is off) as well as functional power button that, when selected by the user, turns the speaker on or off. Also, beneath each listed speaker are three sections: Power State (ON/OFF), SPEAKER battery level (percentage), and SPEAKER signal strength (out of 5 bars) 505.

When the user touches or selects the power button symbol 504, a “power on” or “power off” command is sent from application 400 via transmission by the audio source 300 to turn the speaker 200 on or off. The following Table 1 provides summary of the “power on” and “power off” commands, the speaker 200 response to those commands, and a representative sample code snippet capable of implementing the corresponding command:

TABLE 1

| APP | SPEAKER | |
|---|---|---|
| Command | Response | Sample Code |
| Power On | Speaker power turns | [[CSRGaiaManager |
| | on | sharedInstance] |
| | | setPowerOn:self.powerState]; |
| | | NOTE: self.powerState is true |
| Power Off | Speaker enters SLEEP | [[CSRGaiaManager |
| | mode (powered off) | sharedInstance] |
| | | setPowerOn:self.powerState]; |
| | | NOTE: self.powerState is false |

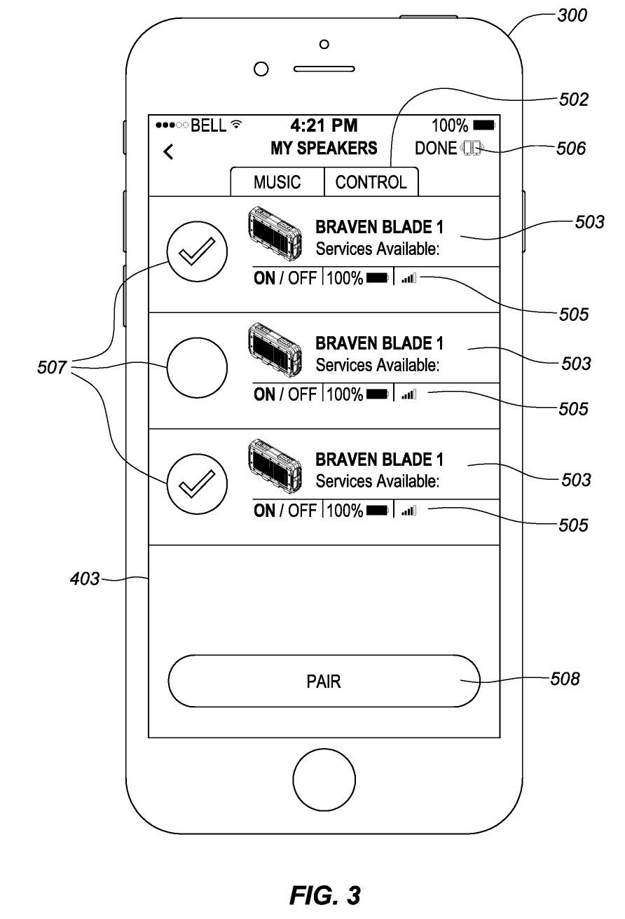

The application 400 also includes a proximity function that can be enabled by the user. When the proximity function is enabled, the application 400 automatically sends a “Power On” command to the speaker 200 when the application 400 determines than an audio source 300 is in connectivity range of the speaker 200. In another embodiment, the proximity “power on” command is sent by the mobile device operating system. In this way, for example, when a user walks into a room that has a speaker that was previously paired with his smartphone (that the user has in hand upon entering the room), the application 400 automatically turns the speaker “on” so that it is available to play audio from the user's smartphone and thereby provides the user with seamless accessibility and use of the speaker. Selecting or tapping on the SPEAKER row “>” 503, generates a screen 403 (FIG. 3) that provides a detailed view of Speaker Controls.

FIG. 3 is a depiction of a screen 403, also under the control tab 502, generated by the application 400 on the touchscreen of the mobile device 100. The screen 403 is similar to the screen 402 depicted in FIG. 2, however, the listing of speakers 503 identifies 3 “Braven Blade” speakers. Also the TWS” button 506 in the top right of the touchscreen is selected, which activates TRUE WIRELESS STEREO (“TWS”) mode. This TWS mode allows the user to select two available speakers to pair with the audio source 300 and thereby receive audio transmission from the audio source via BLE for left-and-right channel wireless stereo output. Selection buttons 507 are provided next to each listed speaker to allow the user to select the speaker the user wishes to pair in TWS mode. Once the speakers are selected, the user selects the pair button 508, which pairs the speakers in TWS mode. The user completes the process by selecting the “DONE” button 509 at the top right of the touch screen display 301 on the audio device 300. The following Table 2 provides summary of the “TWS” command, the speaker 200 response to that command, and a representative sample code snippet capable of implementing the TWS command:

TABLE 2

| APP | SPEAKER | |
|---|---|---|
| Command | Response | Sample Code |
| TWS Select x2 | Speaker 1 | Initiate TWS connection request |
| speakers −> | initiates TWS | for speaker 1. |
| PAIR | pairing request. | [[CSRGaiaManager |
| | Speaker 2 | sharedInstance] startEvent: |
| | receives TWS | 0x4089]; |
| | pairing request. | [[CSRConnectionManager |
| | The two speakers | sharedInstance] |
| | pair over | disconnectPeripheral]; |
| | Bluetooth for | Send pairing request for speaker 2. |
| | left and right | [[CSRGaiaManager |
| | channel stereo | sharedInstance] startEvent: |
| | output. | 0x408A]; |
| | | [[CSRConnectionManager |
| | | sharedInstance] |
| | | disconnectPeripheral]; |
| | | End Session. |
| | | [[CSRGaiaManager |
| | | sharedInstance] startEvent: |
| | | 0x408B]; |
| | | [[CSRConnectionManager |
| | | sharedInstance] |
| | | disconnectPeripheral]; |

In other embodiments, the TRUE WIRELESS STEREO (“TWS”) mode requires a physical button on the speaker to be pressed.

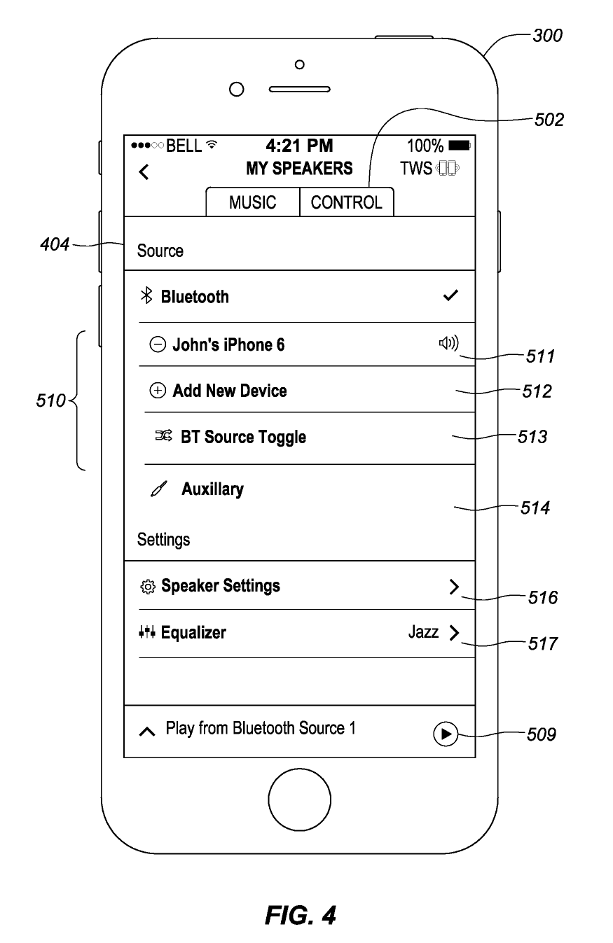

FIG. 4 is a depiction of a screen 404 also under the control tab 502 generated by the application 400 on the touchscreen of the mobile device 100 that provides information on the “audio source.” The “Source” screen 404 defines status and commands used in setting the audio source 300 which plays and transmits audio to the speaker 200. Tapping the “Bluetooth” button 509 expands a submenu 510 where users can select the touchscreen button interfaces to play the currently-connected Bluetooth source (if available) 511, Add a New Device/Source 512, or BT Source Toggle 513 between two connected Bluetooth sources. When the “Add New Device” button is selected the application sends a command that instructs the speaker to go into Bluetooth™ advertising mode, which allows other Bluetooth-enabled devices (smartphones, media players, etc.) to discover and connect to the speaker. When two Bluetooth audio sources are connected to the speaker 200 simultaneously and the user selects the “BT Source Toggle” button 513, the application 400 sends a command instructing the speaker 200 to pause or no longer play audio from the existing connected audio source A and start playing audio from a second audio source B by switching audio output to source B and initiating playback. In this way, the application 400 controls the speaker via BLE commands and manages two concurrent BLE audio sources connected to the speaker. When the user selects button 511, the application 400 sends a command instructing the speaker 200 to play the currently-connected audio source 300. The following Table 3 provides summary of the “Add a New Device/Source” and the “BT Source Toggle” commands, the speaker 200 response to each of those commands, and a representative sample code snippet capable of implementing each of those commands:

TABLE 3

| APP | SPEAKER | |
|---|---|---|
| Command | Response | Sample Code |
| + Add New | Speaker goes into | Add New Device |
| Device | Bluetooth advertising | [[CSRGaiaManager |
| | mode, detectable by | sharedInstance] enterBTpairing]; |
| | other Bluetooth- | |
| | enabled devices | |
| BT Source | Speaker changes audio | BT Source Toggle |
| Toggle | source input from one | [[CSRGaiaManager |
| | connected Bluetooth | sharedInstance] startEvent: |
| | source to a secondary | 0x4055]; //pause the current source |
| | connected Bluetooth | [[CSRGaiaManager |
| | source | sharedInstance] startEvent: |
| | | 0x4056]; //switch a2dp source |
| | | [[CSRGaiaManager |
| | | sharedInstance] startEvent: |
| | | 0x4054]; //play the other source |

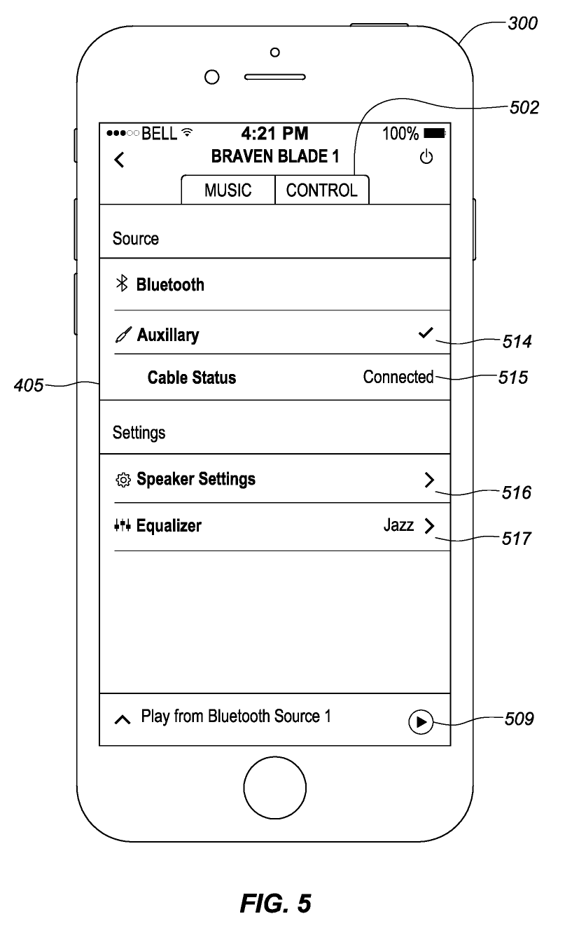

FIG. 5 is a depiction of the auxiliary sub-screen 405 (also under the control tab 502) generated by the application 400 on the touchscreen of the mobile device 100 that provides an interactive menu of “auxiliary” commands. Auxiliary screen 405 is a submenu under the “source” menu depicted in screen 404 that is generated by the application 400 upon selection of the Auxiliary button 514. Selecting (by touching or tapping) the “Auxiliary” button 514 (FIG. 5), the application generates an instruction that commands the speaker 200 to change audio output to the audio source connected via the auxiliary port 201 on the speaker 200. Selection of the Auxiliary button 514 also expands the sub-menu to indicate whether or not the auxiliary port 201 of the speaker is connected to cable 515. The following Table 4 provides a summary of the “Auxiliary” command, the speaker 200 response to that command, and a representative sample code snippet capable of implementing the “Auxiliary” command:

TABLE 4

| APP | SPEAKER | |
|---|---|---|
| Command | Response | Sample Code |
| Auxiliary | Speaker changes audio | Auxiliary |
| | source input to Auxiliary | [[CSRGaiaManager |
| | and plays from the | sharedInstance] startEvent: |
| | connected audio source | 0x403A]; |

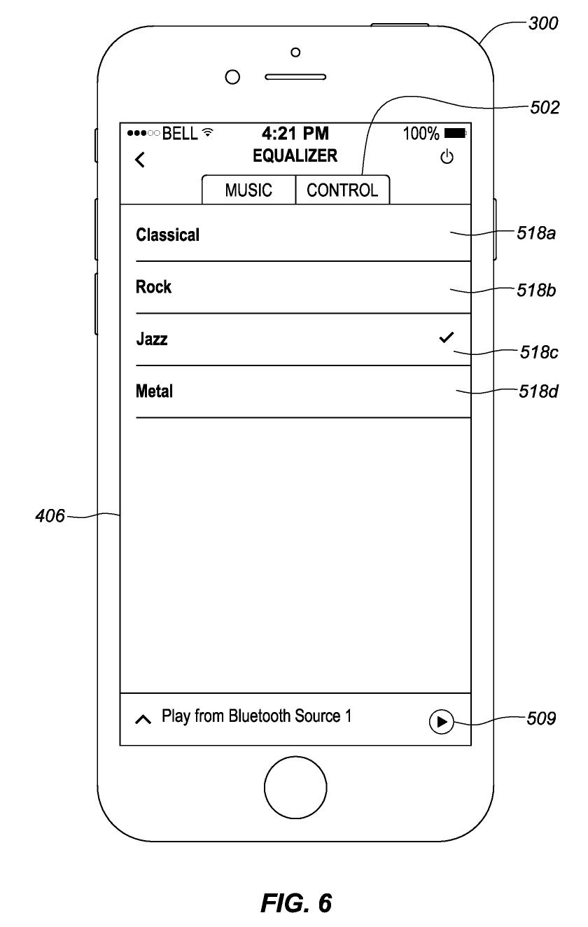

Also included in the Source and Auxiliary screens 404, 405 depicted in FIGS. 4 and 5 is a “Settings” menu/header 516, which indicates commands and controls for speaker-specific settings as well as allowing the user to set custom audio playback equalizer levels. When the equalizer button 517 is selected the “EQ” screen 406 depicted in FIG. 6 is generated by the application 400 and presented on the touchscreen display 301 of the device 300. The EQ settings adjusts the amplitude of audio signals at different frequencies for the speaker. The application generates pre-configured selection genres buttons (classical, rock, jazz, metal) 518a-d that when selected sends out a command that configures the speaker 200 to preset volume levels for different frequencies, achieving different intensities of pitches, bass, etc. In the EQ screen depicted the jazz pre-configured EQ is selected as indicated by the check mark adjacent to that selection button 518c. The following Table 5 provides a summary of the “EQ setting” command, the speaker 200 response to that command, and a representative sample code snippet capable of implementing the “EQ setting” command:

TABLE 5

| APP | SPEAKER | |
|---|---|---|
| Command | Response | Sample Code |
| Select from | Speaker adjusts | Select from preset genres for EQ |
| preset | preset volume | settings |
| genres for EQ | levels for | [payload getBytes:&value |
| settings | different | range:NSMakeRange(1, |
| | frequencies | sizeof(uint8_t))]; |
| | | [self |
| | | getEQGroupParameters:(self.band |
| | | SegmentedControl.selectedSegme |
| | | ntIndex * 4) + 2]; // Band x, Gain, |
| | | Q |
| | | [self |
| | | getEQGroupParameters:(self.band |
| | | SegmentedControl.selectedSegme |
| | | ntIndex * 4) + 2 + 2]; // Band x, |
| | | Filter, Freq |

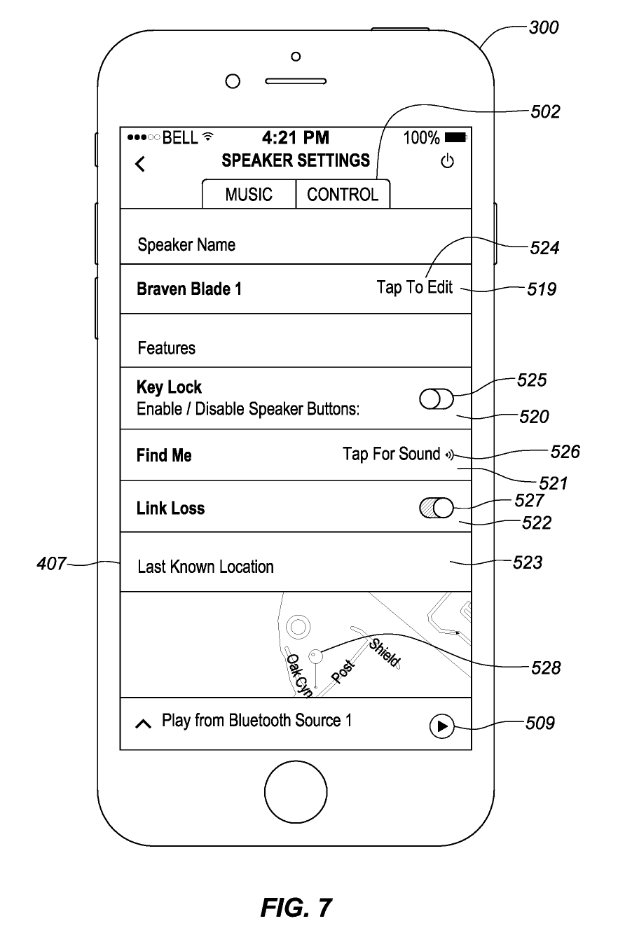

FIG. 7 is a depiction of the “Speaker Settings” screen 407 (also under the control tab 502) generated by the application 400 on the touchscreen of the mobile device 100 that provides an interactive menu of “Speaker Setting” commands, including “Speaker Name Change” 519, “Key Lock” 520, “Find Me” 521, and “Link Loss” 522 features. The “Speaker Settings” screen 407 is generated by the application upon selection of the “Speaker Settings” button 516 depicted on FIG. 5.

When the “Speaker Name change” feature is selected by the user, the application 400 obtains the BLE discovery name of the speaker 200. The BLE discovery name is the name the speaker 200 advertises during the pairing process (e.g., “Braven 1”). The application 400 allows the user to set a custom name by tapping the edit button 524 and typing in on (or otherwise inputting to) the audio source device 300 a new name and then instructing the speaker 200 to update its BLE advertising name to the new name inputted by the user.

The Key Lock feature 520 prevents physical button interaction on the speaker, such that the speaker's physical button interfaces such as the play button, volume buttons, etc. have no functional response when Key Lock feature 520 is turned “ON”. In operation the user selects on and off button 525 on the Key Lock feature 520, which the application 400 recognizes and generates and sends the corresponding instructions to the speaker 200 to disable the functionality of the physical buttons.

The “Find Me” feature 521 instructs the speaker to play an audio cue, so that the user can locate a lost or misplaced speaker 200. In operation the user selects the sound button 526 on the Find Me feature 521. In response, the application 400 recognizes the selection and generates and sends the corresponding instructions to the speaker 200 to generate an audio cue. The user can cancel the audio cue by engaging the sound button 526, in which case the application 400 recognizes the user input and generates and sends the corresponding instructions to the speaker 200 to cancel the audio cue.

The Link Loss feature 522 functions to activate a proximity alarm on the audio source device 300 and speaker 200, such that when the Bluetooth signal strength between the audio source device 300 and speaker 200 drops low, an alarm will sound on both the audio source device 300 as well as speaker 200 to indicate to the user that audio playback is in danger of dropping out. In operation, the user can turn “On” or “Off” the Link Loss feature 522 with the button 527. The application 400 recognizes whether the feature is on or off and if on send a instructions to the audio source device 300 as well as speaker 200 to sound the alarm when BLE signal strength drops below a pre-defined strength or level.

The following Table 6 provides a summary of each of the commands for the “Speaker Name Change” 519, “Key Lock” 520, “Find Me” 521, and “Link Loss” 522 features, the speaker 200 response to each of those commands, and a representative sample code snippet capable for implementing the command:

TABLE 6

| APP | SPEAKER | |
|---|---|---|
| Command | Response | Sample Code |
| Set | Speaker Bluetooth | Set custom Speaker Name |
| custom | advertising name | [[CSRGaiaManager |
| Speaker | updates | sharedInstance] |
| Name | | storePSKey:1:name]; |
| | | [[CSRGaiaManager |
| | | sharedInstance] startEvent: |
| | | 0x471C]; |
| Find Me | Speaker sounds | Find Me Tapped |
| Tapped | audio cue | [[CSRConnectionManager |
| | | sharedInstance] setIntValue:@″0x1 |
| | | 802″ characteristic:@“0x2A06″ |
| | | value:2]; |
| | | Find Me Cancelled |
| | | [[CSRConnectionManager |
| | | sharedInstance] setIntValue:@″0x1 |
| | | 802″ characteristic:@″0x2A06″ va |
| | | lue:0]; |
| Link | When BT signal | Link Loss ON |
| Loss ON | strength is low, | [[CSRConnectionManager |
| | phone and | sharedInstance] |

| | |
|---|---|
| speaker will | setIntValue:ksLinkLoss |
| sound audio cue | characteristic:kcAlertLevel |
| | value:2 |
| | success:\hat{ }( ) { } |

| | | |
|---|---|---|
| | | failure:\hat{ }(NSError *error) { }]; |
| Key Lock | Speaker physical | Key Lock |
| | buttons do not | [[CSRGaiaManager |
| | function when | sharedInstance] startEvent: |
| | Key Lock is | 0x4030]; |
| | turned “ON” | Unlock Keys |
| | | [[CSRGaiaManager |
| | | sharedInstance] startEvent: |
| | | 0x4031]; |

Also provided in the “Speaker Settings” screen 407 depicted in FIG. 7 is the Last Known Location feature 523, which provides users with a map location pin drop indicating the location at which the speaker 200 was last connected to the audio source device 300. When the application 400 recognizes a drop in BLE connection with the speaker 200, the application instructs the audio device's Location Services functionality (a combination of Wi-Fi, GPS, or cellular data services) to calculate and/or log the current location of the audio source, by dropping a location or map pin 528 at the current location. The location pin 528 thereby acts as a reminder or log representing the Last Known Location of audio source 300 and hence last known proximity of the speaker 200. The following Table 7 provides a summary of “Last Known Location” command, the speaker 200 response to the command, and a representative sample code snippet capable of implementing the command:

TABLE 7

| APP | SPEAKER | |
|---|---|---|
| Command | Response | Sample Code |
| Detect when | n/a | 1. On app launch in “viewdidload” |
| SPEAKER | | we initiate the location services with |
| disconnects, | | the below code: |
| drop pin | | locationManager = |
| at user's | | [[CLLocationManager alloc] init]; |
| current | | locationManager.delegate = self; |
| location | | [locationManager |
| | | requestAlwaysAuthorization]; |
| | | locationManager.desiredAccuracy |
| | | = kCLLocationAccuracyBest; |
| | | We enable “Location Updates” |
| | | background mode in capabilities |
| | | 2. In |
| | | -(void) |
| | | centralManager:(CBCentralMana |
| | | ger *)central |
| | | didDisconnectPeripheral:(CBPerip |
| | | heral *)peripheral error:(NSError |
| | | *)error |
| | | method when the peripheral gets |
| | | disconnected, we get the |
| | | “currentlocation” latitude and |
| | | longitude and cache the coordinates |
| | | to show in mapview. |
| | | currentLocation.coordinate.latitud |
| | | e |
| | | currentLocation.coordinate.longitu |
| | | de |
| | | 3. We add mapview using the below |
| | | code: |

self.mapView = [[MKMapView

alloc] init];

```
  self.mapView.delegate = self;
  self.mapView.frame =
```

CGRectMake(0, 362, 320, 136);

self.mapView.mapType =

MKMapTypeStandard;
And mark the cached coordinates
using the below code:
NSMutableArray * locationarray
= [[NSMutableArray alloc]
initWithContentsOfFile:savepath];

CLLocationCoordinate2D

coordinate_location;

coordinate_location.latitud

e =
[[locationarray objectAtIndex:2] d
oubleValue];
coordinate_location.longitude =
[[locationarray objectAtIndex:3] d
oubleValue];
MKCoordinateRegion region
= MKCoordinateRegionMakeWith
Distance(coordinate_location, 5, 5)
;
[self.mapView setRegion:[self.map
View regionThatFits:region] anim
ated:YES];

It should be understood that each of the foregoing interactive screens and commands are generated by the application 400 using the microprocessor(s) of the audio source 300. Each of the commands (as well as the audio) are transmitted from the BLE module of the audio source to the BLE chip/module 202 that is contained within the speaker 200 and that controls the operation of the speaker 200 alone or through additional microprocessors and circuits contained within the speaker 200. Information or data from the speaker 200 is transmitted from the BLE chip 202 in the speaker and received by the BLE module in the audio source.

In some embodiments, the placement and access to each feature are only viewable or accessible once the user is connected to and paired to a speaker over BLE.

Each of the foregoing and various aspects, together with those set forth in the claims and described in connection with the embodiments of the protective cases summarized above or otherwise disclosed herein including the drawings may be combined as claim limitations for a device, apparatus, system, method of manufacture, and/or use.

Although the various inventive aspects are herein disclosed in the context of certain preferred embodiments, implementations, and examples, it should be understood by those skilled in the art that the present invention extends beyond the specifically disclosed embodiments to other alternative embodiments and/or uses of the invention and obvious modifications and equivalents thereof. In addition, while a number of variations of the various aspects have been shown and described in detail, other modifications, which are within their scope will be readily apparent to those of skill in the art based upon this disclosure. It should be also understood that the scope this disclosure includes the various combinations or sub-combinations of the specific features and aspects of the embodiments disclosed herein, such that the various features, modes of implementation, and aspects of the disclosed subject matter may be combined with or substituted for one another. Thus, it is intended that the scope of the present invention herein disclosed should not be limited by the particular disclosed embodiments or implementations described above.

What is claimed is:

1. An interactive remote controlled speaker system comprising:
a wireless portable BLE enabled speaker;
a software application configured to interact with said speaker via a BLE connection and control the speaker's functionality through a user interface that results in instructions to the speaker; and
wherein said software application is configured to monitor the BLE connectivity strength between the BLE speaker and a system running the app and map the location of the system running the app when the connectivity falls below a predefined level.

2. An interactive remote controlled speaker system comprising:
a wireless portable BLE enabled speaker;
a software application configured to interact with said speaker via a BLE connection and control the speaker's functionality through a user interface that results in instructions to the speaker; and
wherein said software application is configured to automatically turn on the speaker for operation of playing audio when the BLE connectivity strength between the BLE speaker and a system running the app is determined by the application to above a predefined level.

3. An interactive remote controlled speaker system comprising:
a wireless portable BLE enabled speaker;
a software application configured to interact with said speaker via a BLE connection and control the speaker's functionality through a user interface that results in instructions to the speaker; and
wherein said software application is configured to automatically initiate an audible or visual alarm on speaker and a system running the app connected via BLE to the speaker when the BLE connectivity strength between the BLE speaker and a system running the app is determined by the application to fall below a predefined level.

4. An interactive remote controlled speaker system comprising:
a first wireless portable BLE enabled speaker;
a second wireless portable BLE enabled speaker;
a software application configured to interact with said first and second speakers via a BLE connection and control each of the speaker's functionality through a user interface that results in instructions to the speakers; and
wherein said software application is configured to toggle audio transmission from a system running the app between the first and second speaker when the user selects a toggle switch presented by the software application.

5. An interactive remote controlled speaker system comprising:
a wireless portable BLE enabled speaker having physical user interface buttons including volume and power buttons;
a software application configured to interact with said speaker via a BLE connection and control the speaker's functionality through a user interface that results in instructions to the speaker; and
wherein said software application is configured to disable the functionality of the physical user interface buttons when the user selects a disabling button presented by the software application.

6. An interactive remote controlled speaker system comprising:
a wireless portable BLE enabled speaker;
a software application configured to interact with said speaker via a BLE connection and control the speaker's functionality through a user interface that results in instructions to the speaker; and
wherein said software application is configured to initiate a pre-determined audio cue to be played by a BLE speaker when the user selects a button presented by the application to initiate the audio cue.

7. An interactive remote controlled speaker system comprising:
a wireless portable BLE enabled speaker;
a software application configured to interact with said speaker via a BLE connection and control the speaker's functionality through a user interface that results in instructions to the speaker; and
wherein said software application is configured to obtain and the BLE discovery name of the speaker and transmit instructions to the speaker to advertise a new name discovery name inputted by the user through the application.

8. An interactive remote controlled speaker system comprising:
a wireless portable BLE enabled speaker;
a software application configured to interact with said speaker via a BLE connection and control the speaker's functionality through a user interface that results in instructions to the speaker; and
wherein said software application is configured to provide a set of pre-defined speaker equalizer settings that are selectable by the user and instruct the speaker to employ a user selected equalizer setting via a instructions to the speaker transmitted to the speaker through a BLE connection.
